(19) United States
(12) Patent Application Publication
(10) Pub. No.: US 2018/0196188 A1
(43) Pub. Date: Jul. 12, 2018

(54) BACKLIGHT MODULE AND FABRICATING METHOD THEREOF, AND TWO-SIDED DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Kai Yan, Beijing (CN); Liangming Luo, Beijing (CN); Woong Kim, Beijing (CN); Zhanchang Bu, Beijing (CN)

(21) Appl. No.: 15/112,898

(22) PCT Filed: Jan. 6, 2016
(86) PCT No.: PCT/CN2016/070234

§ 371 Date: Jul. 20, 2016

(30) Foreign Application Priority Data
Jul. 27, 2015 (CN) 201510446791.5

(51) Int. Cl. F21V 8/00; G02F 1/1335

(52) U.S. Cl. CPC G02B 6/0056; G02B 6/0063; G02F 2001/133342; G02B 6/0053; G02F 2203/09; G02F 1/13362

(57) ABSTRACT

A backlight module, a fabricating method thereof, and a two-sided display device are provided. The backlight module includes a first transflective unit, a second transflective unit, and a bidirectional backlight source disposed between the first transflective unit and the second transflective unit. The bidirectional backlight source is configured to emit light both in a direction toward the first transflective unit and in a direction toward the second transflective unit, and is configured to transmit light from the direction of the first transflective unit and light from the direction of the second transflective unit. The first transflective unit is configured to transmit light in a first polarization direction and reflect light in a second polarization direction, the second transflective unit is configured to transmit light in the second polarization direction and reflect light in the first polarization direction, and the first polarization direction is perpendicular to the second polarization direction.

### CROSS REFERENCE TO RELATED APPLICATION

This application is a National Stage Entry of PCT/CN2016/070234, filed Jan. 6, 2016, which claims the benefit and priority of Chinese Patent Application No. 201510446791.5 filed Jul. 27, 2015. The entire disclosure of each of the above applications are incorporated herein by reference.

### BACKGROUND

Embodiments of the present disclosure relate to the field of display technologies, and more particularly, to a backlight module and a fabricating method thereof, and a two-sided display device.

With diversification of display requirements, in addition to traditional one-sided display, it is necessary to provide a display device having other display modes, for example, a display device capable of simultaneously displaying on two sides.

In a two-sided liquid crystal display device in the prior art, two liquid crystal display devices are simply superposed back to back, and either liquid crystal display device includes a backlight module and a liquid crystal display panel. FIG. 1 shows a schematic structural diagram of a two-sided liquid crystal display device in the prior art, which includes two backlight modules (whose reference numerals are not shown in FIG. 1), and two liquid crystal display panels 120 and 220, where a first backlight module includes a backlight source 111 and a polarizer 112, a second backlight module includes a backlight source 211 and a polarizer 212, the first backlight module and the liquid crystal display panel 120 constitute an independent liquid crystal display device 100, the second backlight module and the liquid crystal display panel 220 constitute the other independent liquid crystal display device 200, and the two liquid crystal display devices do not interfere with each other in display.

As shown in FIG. 1, in a process of display, the presence of the polarizers only allows polarized light (supposing p light) polarized in one direction to transmit through, and polarized light (s light) perpendicular to the polarization direction of the former polarized light is filtered out, which may greatly reduce the efficiency of light energy utilization of the backlight modules.

### BRIEF DESCRIPTION

Embodiments of the present disclosure provide a backlight module and a fabricating method thereof, and a two-sided display device, which are configured to improve the efficiency of light energy utilization of a backlight module.

According to a first aspect of the embodiments of the present disclosure, there is provided a backlight module, including:

a first transflective unit, a second transflective unit, and a bidirectional backlight source disposed between the first transflective unit and the second transflective unit, wherein the bidirectional backlight source is configured to emit light both in a direction toward the first transflective unit and in a direction toward the second transflective unit, and is configured to transmit light from the direction of the first transflective unit and light from the direction of the second transflective unit; the first transflective unit is configured to transmit light in a first polarization direction and reflect light in a second polarization direction; the second transflective unit is configured to transmit light in the second polarization direction and reflect light in the first polarization direction; and the first polarization direction is perpendicular to the second polarization direction.

In one embodiment, the bidirectional backlight source includes a light guide plate and a light source disposed at a side edge of the light guide plate.

In one embodiment, at least one of the first transflective unit and the second transflective unit includes a transflective film, a transflective lens, or an oblique plate stack superposed by glass.

In one embodiment, the backlight module further includes a depolarizing film disposed between the first transflective unit and the second transflective unit.

In one embodiment, the depolarizing film is disposed between the bidirectional backlight source and the first transflective unit and is configured to depolarize light in the second polarization direction to be light in the first polarization direction and light in the second polarization direction, and to at least transmit light in the first polarization direction.

In one embodiment, the depolarizing film is disposed between the bidirectional backlight source and the second transflective unit and is configured to depolarize light in the first polarization direction to be light in the first polarization direction and light in the second polarization direction, and to at least transmit light in the second polarization direction.

In one embodiment, the backlight module further includes at least one of a first polarizer and a second polarizer, wherein the first polarizer is disposed at a side of the first transflective unit opposite the bidirectional backlight source and is configured to transmit light in the first polarization direction and filter out light in the second polarization direction; and the second polarizer is disposed at a side of the second transflective unit opposite the bidirectional backlight source and is configured to transmit light in the second polarization direction and filter out light in the first polarization direction.

In one embodiment, light in the first polarization direction is one of p light and s light, and light in the second polarization direction is the other one of p light and s light.

According to a second aspect of the embodiment of the present disclosure, there is provided a method for fabricating a backlight module, including:

providing a first transflective unit, a second transflective unit and a bidirectional backlight source; and

disposing the bidirectional backlight source between the first transflective unit and the second transflective unit, where the bidirectional backlight source is configured to emit light both in a direction toward the first transflective unit and in a direction toward the second transflective unit, and is configured to transmit light from the direction of the first transflective unit and light from the direction of the second transflective unit; the first transflective unit is configured to transmit light in a first polarization direction and reflect light in a second polarization direction; the second transflective unit is configured to transmit light in the second polarization direction and reflect light in the first polarization direction; and the first polarization direction is perpendicular to the second polarization direction.

In one embodiment, the step of disposing the bidirectional backlight source between the first transflective unit and the second transflective unit includes:

attaching the first transflective unit and the second transflective unit on two opposite surfaces of the bidirectional backlight source, respectively.

According to a third aspect of the embodiments of the present disclosure, there is provided another backlight module, including:

a first reflective brightness enhancement unit, a second reflective brightness enhancement unit, and a bidirectional backlight source disposed between the first reflective brightness enhancement unit and the second reflective brightness enhancement unit, where the bidirectional backlight source is configured to emit light both in a direction toward the first reflective brightness enhancement unit and in a direction toward the second reflective brightness enhancement unit, and is configured to transmit light from the direction of the first reflective brightness enhancement unit and light from the direction of the second reflective brightness enhancement unit; both the first reflective brightness enhancement unit and the second reflective brightness enhancement unit are configured to transmit light in a first polarization direction, depolarize light in a second polarization direction to be light in the first polarization direction and light in the second polarization direction, then reflect both the depolarized light in the first polarization direction and the depolarized light in the second polarization direction back to the bidirectional backlight source; and the first polarization direction is perpendicular to the second polarization direction.

In one embodiment, the bidirectional backlight source includes a light guide plate and a light source disposed at a side edge of the light guide plate.

In one embodiment, the first reflective brightness enhancement unit includes a first transflective unit and a first depolarizing film disposed between the first transflective unit and the bidirectional backlight source; and/or

the second reflective brightness enhancement unit includes a second transflective unit and a second depolarizing film disposed between the second transflective unit and the bidirectional backlight source.

In one embodiment, the backlight module further includes a first polarizer and a second polarizer, where the first polarizer is disposed at a side of the first reflective brightness enhancement unit opposite the bidirectional backlight source; the second polarizer is disposed at a side of the second reflective brightness enhancement unit opposite the bidirectional backlight source; and both the first polarizer and the second polarizer are configured to transmit light in the first polarization direction and filter out light in the second polarization direction.

In one embodiment, light in the first polarization direction is one of p light and s light, and light in the second polarization direction is the other one of p light and s light.

According to a fourth aspect of the embodiments of the present disclosure, there is provided another method for fabricating a backlight module, including:

providing a first reflective brightness enhancement unit, a second reflective brightness enhancement unit and a bidirectional backlight source; and

disposing the bidirectional backlight source between the first reflective brightness enhancement unit and the second reflective brightness enhancement unit, where the bidirectional backlight source is configured to emit light both in a direction toward the first reflective brightness enhancement unit and in a direction toward the second reflective brightness enhancement unit, and is configured to transmit light from the direction of the first reflective brightness enhancement unit and light from the direction of the second reflective brightness enhancement unit; both the first reflective brightness enhancement unit and the second reflective brightness enhancement unit are configured to transmit light in a first polarization direction, depolarize light in a second polarization direction to be light in the first polarization direction and light in the second polarization direction, then reflect both the depolarized light in the first polarization direction and the depolarized light in the second polarization direction back to the bidirectional backlight source; and the first polarization direction is perpendicular to the second polarization direction.

According to a fifth aspect of the embodiments of the present disclosure, there is further provided a two-sided display device, including: a first display panel, a second display panel, and a backlight module disposed between the first display panel and the second display panel, where the backlight module is the backlight module according to the foregoing first aspect or the foregoing third aspect.

The backlight modules provided by the embodiments of the present disclosure enable components of light in two mutually perpendicular polarization directions to be fully utilized by different display panels, or converts unavailable polarized light in a particular polarization direction to available polarized light in another polarization direction, so that the two-sided display device using any of the backlight modules provided by the embodiments of the present disclosure has higher efficiency of light energy utilization.

### BRIEF DESCRIPTION OF THE DRAWINGS

To more clearly describe the embodiments of the present disclosure, the following will briefly introduce the accompanying drawings required for describing the embodiments.

FIG. 1 shows a schematic structural diagram of a two-sided display device in the prior art;

FIG. 2 shows a schematic structural diagram of a backlight module according to the embodiments of the present disclosure;

FIG. 3 shows a schematic structural diagram of an embodiment of a transflective unit as shown in FIG. 2; and

FIG. 4 shows a schematic structural diagram of another embodiment of a backlight module according to the embodiments of the present disclosure.

### DETAILED DESCRIPTION

To make the present disclosure clearer, the following clearly and completely describes embodiments of the present disclosure with reference to the accompanying drawings. It should be apparent that the described embodiments are some but not all of the embodiments of the present disclosure. All other embodiments obtained by a person of ordinary skill in the art based on the embodiments of the present disclosure without creative efforts shall fall within the protection scope of the present disclosure.

According to an embodiment of the present disclosure, there is provided a backlight module. As shown in FIG. 2, the backlight module includes a first transflective unit 103, a second transflective unit 104, and a bidirectional backlight source 101 disposed between the first transflective unit 103 and the second transflective unit 104, wherein the first transflective unit 103 is configured to transmit light (for example, p light) in a first polarization direction and reflect light (for example, s light) in a second polarization direction; the second transflective unit 104 is configured to transmit light in the second polarization direction and reflect light in the first polarization direction; the first polarization direction is perpendicular to the second polarization direction. The bidirectional backlight source 101 described herein can emit light both in a direction toward the first transflective unit 103 and in a direction toward the second transflective unit 104, and can transmit light from the direction of the first transflective unit 103 and from the direction of the second transflective unit 104.

As an example, an operating principle of the foregoing backlight module provided by the embodiments of the present disclosure will be explained with reference to FIG. 2.

Referring to FIG. 2, for light emitted towards the first transflective unit 103 (namely, upwards), p light therein can transmit through the first transflective unit 103 and continue transmitting upwards so that the p light may be utilized by the liquid crystal display panel positioned above, whereas s light is reflected back to the bidirectional backlight source 101. Since the bidirectional backlight source 101 can transmit light from the first transflective unit 103, the s light may transmit through the bidirectional backlight source 101, reach and transmit through the second transflective unit 104 positioned beneath the bidirectional backlight source 101 so that the s light is utilized by the liquid crystal display panel positioned beneath. Likewise, for light emitted towards the second transflective unit 104 (namely, downwards), s light therein can transmit through the bidirectional backlight source 101 and is utilized by the liquid crystal display panel positioned beneath, whereas p light may be reflected to the first transflective unit 103 and transmit through the first transflective unit 103 so that the p light is utilized by the liquid crystal display panel positioned above.

According to the backlight module provided by the embodiments of the present disclosure, both s light and p light are fully utilized, instead of filtering out the light polarized in one direction. Therefore, the efficiency of light energy utilization may be significantly improved for the bidirectional backlight source 101.

As shown in FIG. 2, in a specific embodiment, the bidirectional backlight source 101 described herein may include: a light guide plate 101a and a light source 101b disposed at a side edge of the light guide plate. The light guide plate 101a is pervious to light, and no light-shielding or total-reflection structure is disposed between the light guide plate 101a and the first transflective unit 103 and between the light guide plate 101a and the second transflective unit 104. Therefore, the bidirectional backlight source 101 is configured to emit light both in a direction toward the first transflective unit 103 and in a direction toward the second transflective unit 104. Of course, in practical application, other structures may also be adopted for the foregoing bidirectional backlight source 101.

As shown in FIG. 2, in specific implementation, the foregoing backlight module may further include a first polarizer 105 disposed at a side (namely, above the first transflective unit 103) of the first transflective unit 103 away from the bidirectional backlight source 101, and a second polarizer 106 disposed at a side (namely, beneath the second transflective unit 104) of the second transflective unit 104 away from the bidirectional backlight source 101, where the first polarizer 105 is configured to transmit p light and filter out s light, and the second polarizer is configured to transmit s light and filter out p light.

Due to reasons of fabricating technologies, the first transflective unit 103 likely cannot completely reflect s light but transmits a little s light, and correspondingly a little p light may likely transmit through the second transflective unit 104, which may have a negative effect on the display effect of the liquid crystal display panels. In the embodiments of the present disclosure, by respectively disposing a first polarizer 105 and a second polarizer 106 above the first transflective unit 103 and beneath the second transflective unit 104, respectively, a potential is reduced that s light transmitted upwards through the first transflective unit 103 has a negative effect on display of the liquid crystal display panel above and that p light transmitted downwards through the second transflective unit 103 has a negative effect on display of the liquid crystal display panel beneath. Of course it is understood that in practical application, the first polarizer and the second polarizer as mentioned above may also be not provided when the transflective units are good enough in performance or the negative effect on the display effect for the above reasons can be avoided in other ways.

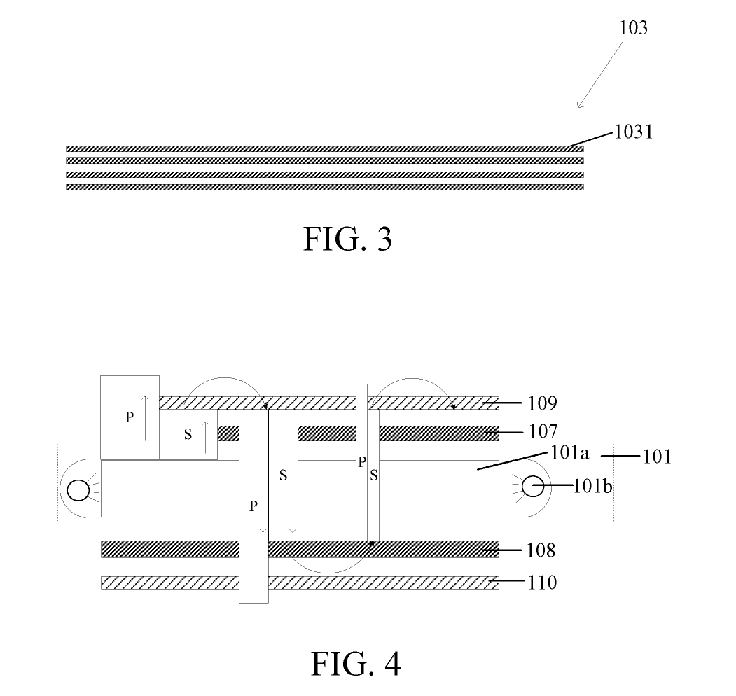

In a specific embodiment, as shown in FIG. 3, the foregoing first transflective unit 103 may include an oblique plate stack superposed by glass 1031. Likewise, the foregoing second transflective unit 104 also may be an oblique plate stack superposed by glass. Of course in practical application, other structures (for example, a transflective film or a transflective lens and so on) may be used as transflective units to implement corresponding functions. The particular structure of the transflective unit does not affect the scope of protection of the present disclosure.

In a specific embodiment, also a depolarizing film may be disposed between the first transflective unit 103 and the second transflective unit 104. The depolarizing film may be disposed between the light guide plate 101a and the first transflective unit 103 and is configured to depolarize s light to be one half of s light and one half of p light and transmit the p light thereof. The depolarizing film also may be disposed between the second transflective unit 104 and the light guide plate 101a and is configured to depolarize p light to be one half of s light and one half of p light and transmit the s light thereof. Also, in another embodiment, between the light guide plate 101a and the first transflective unit 103 as well as between the second transflective unit 104 and the light guide plate 101a, there is respectively provided a depolarizing film. It is readily understood that without regard to whether the depolarizing film is configured to depolarize s light or p light, and without regard to the location at which the depolarizing film is disposed between the first transflective unit 103 and the second transflective unit 104, in the corresponding backlight module provided by this embodiment, p light may exit only through the first transflective unit 103, s light may exit only through the second transflective unit 104, and light that cannot exit through the first transflective unit 103 or the second transflective unit 104 is finally reflected or depolarized to be light that can be emitted.

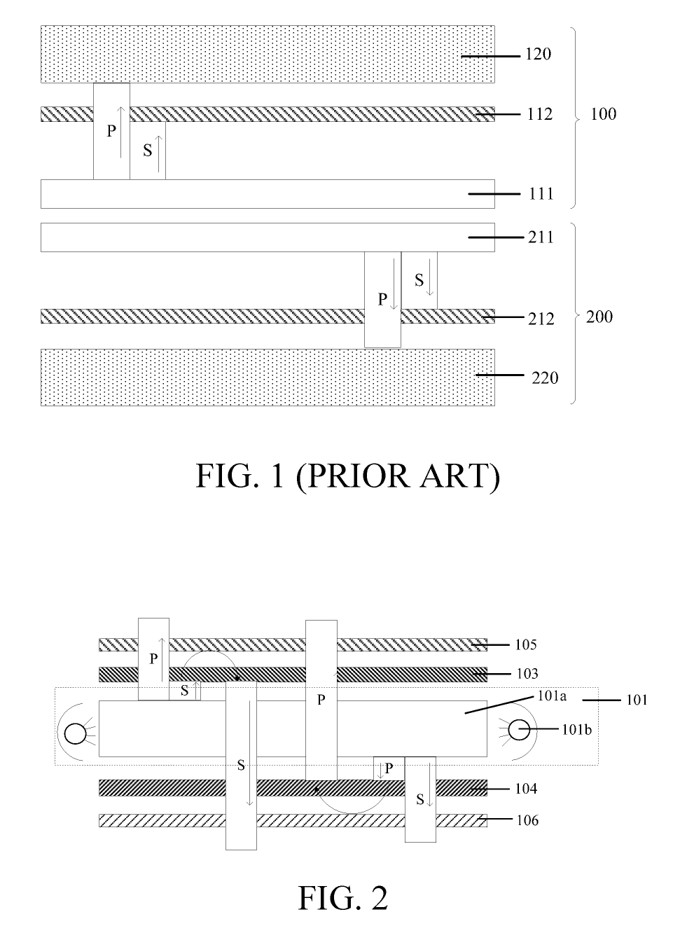

In another aspect, the embodiments of the present disclosure further provide a method for fabricating the backlight modules in FIG. 1, and the method may specifically include:

providing a first transflective unit, a second transflective unit and a bidirectional backlight source; and

disposing the bidirectional backlight source between the first transflective unit and the second transflective unit, wherein the bidirectional backlight source is configured to emit light both in a direction toward the first transflective unit and in a direction toward the second transflective unit, and is configured to transmit light from the direction of the first transflective unit and light from the direction of the second transflective unit; the first transflective unit is configured to transmit light in a first polarization direction and reflect light in a second polarization direction; the second transflective unit is configured to transmit light in the second polarization direction and reflect light in the first polarization direction; and the first polarization direction is perpendicular to the second polarization direction.

In a specific embodiment, the first transflective unit and the second transflective unit may be respectively attached on an upper surface and a lower surface of the bidirectional backlight source, or through a backplate having a particular structure, the first transflective unit and the second transflective unit are respectively disposed above and beneath the bidirectional backlight source.

Embodiments of the present disclosure further provide another backlight module. Referring to FIG. 4, the backlight module is different from the backlight module provided in the embodiment as shown in FIG. 2 in that a first reflective brightness enhancement unit 107 and a second reflective brightness enhancement unit 108 are respectively disposed above and beneath the bidirectional backlight source 101. Both the first reflective brightness enhancement unit 107 and the second reflective brightness enhancement unit 108 are configured to transmit light (likewise supposing p light) in a first polarization direction, and depolarize light (s light) in a second polarization direction to be light in the first polarization direction and light in the second polarization direction, then reflect the light in the first polarization direction and the light in the second polarization direction back to the bidirectional backlight source. The first polarization direction is perpendicular to the second polarization direction.

In addition, like the embodiment as shown in FIG. 1, a polarizer 109 may be disposed above the first reflective brightness enhancement unit 107, and a polarizer 110 may be disposed beneath the second reflective brightness enhancement unit 108. However, what is different from the embodiment as shown in FIG. 1 is that both the polarizer 109 and the polarizer 110 are configured to transmit p light.

Likewise, the operating principle of another backlight module provided by the embodiments of the present disclosure is explained with reference to FIG. 4. For light emitted by the bidirectional backlight source 101 and propagated upwards, p light having ½ energy thereof can transmit through the first reflective brightness enhancement unit 107 and is propagated upwards so as to be utilized by the liquid crystal display panel positioned above; whereas s light having ½ energy thereof may be depolarized to be s light having ¼ energy and p light having ¼ energy, which may be reflected to the second reflective brightness enhancement unit 108. The p light having ¼ energy obtained after the s light having ½ energy is depolarized may transmit through the second reflective brightness enhancement unit 108 and is propagated downwards so as to be utilized by the liquid crystal display panel positioned beneath, and the resulting s light having ¼ energy is again depolarized to be s light having ⅛ energy and p light having ⅛ energy which is propagated upwards. In this way, s light is finally completely depolarized and converted to p light. Likewise, s light among light emitted by the bidirectional backlight source 101 and propagated downwards also can be converted to p light through the first reflective brightness enhancement unit 107 and the second reflective brightness enhancement unit 108 and exit out, which is not explained in detail herein. According to the backlight module provided by the embodiments of the present disclosure, since unavailable s light having ½ energy is converted to available p light, the efficiency of light energy utilization can be significantly improved.

The structure of the bidirectional backlight source in this embodiment may be consistent with that of the bidirectional backlight source in the foregoing embodiments, and thus is not described in detail herein.

In a specific embodiment, the first reflective brightness enhancement unit 107 herein may include a first transflective unit and a first depolarizing film disposed between the first transflective unit and the bidirectional backlight source. Correspondingly, the second reflective brightness enhancement unit 108 may also include a second transflective unit and a second depolarizing film disposed between the second transflective unit and the bidirectional backlight source. Of course in other embodiments, also other structures having corresponding functions may be adopted for the first reflective brightness enhancement unit and/or the second reflective brightness enhancement unit herein.

Likewise, in the embodiments of the present disclosure, the two disposed polarizers 109 and 110 also can play a role in preventing leaked s light from having a negative effect on the display effect of the display panels.

It should be noted that although in the foregoing embodiments it is explained by taking the first polarized light as p light and the second polarized light as s light, it is understood that the same technical effect can be achieved when the first polarized light is s light and the second polarized light is p light, and corresponding embodiments shall fall within the scope of protection of the present disclosure.

In another aspect, the embodiments of the present disclosure further provide a method for fabricating the backlight modules in FIG. 4, and the method may specifically include:

providing a first reflective brightness enhancement unit, a second reflective brightness enhancement unit and a bidirectional backlight source; and

disposing the bidirectional backlight source between the first reflective brightness enhancement unit and the second reflective brightness enhancement unit, wherein the bidirectional backlight source is configured to emit light both in a direction toward the first reflective brightness enhancement unit and in a direction toward the second reflective brightness enhancement unit, and is configured to transmit light from the direction of the first reflective brightness enhancement unit and light from the direction of the second reflective brightness enhancement unit; both the first reflective brightness enhancement unit and the second reflective brightness enhancement unit are configured to transmit light in a first polarization direction, depolarize light in a second polarization direction to be light in the first polarization direction and light in the second polarization direction, and then reflect the light in the first polarization direction and the light in the second polarization direction back to the bidirectional backlight source; and the first polarization direction is perpendicular to the second polarization direction.

In a specific embodiment, the first reflective brightness enhancement unit and the second reflective brightness enhancement unit may be respectively attached on the upper surface and the lower surface of the bidirectional backlight source, or through a backplate having a particular structure, the first reflective brightness enhancement unit and the second reflective brightness enhancement unit are respectively disposed above and beneath the bidirectional backlight source.

In still another aspect, the embodiments of the present disclosure further provide a two-sided display device, and the two-sided display device includes: a first display panel, a second display panel, and a backlight module disposed between the first display panel and the second display panel, wherein the backlight module herein is the backlight module in any one of the foregoing embodiments.

The two-sided display device herein may be any product having the display function, such as a mobile phone, a computer, a PAD, a palm computer, an e-book and so on.

It should be explained that the orientation or position relations represented by the terms of “up”, “above”, “down”, “beneath”, “top”, “bottom”, “between” and the like used in the description of the present disclosure are relative orientation or position relations shown based on the accompanying figures, and are merely for ease of a description of the present disclosure and a simplified description instead of being intended to indicate or imply the device or element to have a special orientation or to be configured and operated in a special orientation. Thus, they cannot be understood as limiting of the present disclosure. In addition, when an element or layer is referred to as being “on” another element or layer, it may be directly on the other element or layer, or intervening elements or layers may be present. Likewise, when an element or layer is referred to as being “beneath” another element or layer, it may be directly beneath the other element or layer, or at least one intervening element or layer may be present. When an element or layer is referred to as being “between” two elements or two layers, it may be unique element or layer between the two elements or two layers, or at least one intervening element or layer may be present.

In addition, when an element and an embodiment thereof in this application are introduced, articles “a” “an”, “the” and “said” may be intended to indicate one or more elements are present. Unless otherwise stated, “multiple” means two or more than two. The terms “comprise”, “include”, “contain” and “have” are inclusive and therefore specify the presence of other elements excluding the elements listed out. The terms “first”, “second”, “third” and so on are merely for description purposes, and are not construed as indicating or implying relative importance.

The abovementioned embodiments are merely the specific embodiments of the present disclosure, and the scope of protection of the present disclosure is not limited to this. Any variation or substitution easily conceivable to a person of skilled in the art within the technical scope disclosed in the present disclosure shall fall within the scope of protection of the present disclosure. Therefore, the scope of protection of the present disclosure shall be subject to the scope of protection of the claims.

1. A backlight module, comprising:
a first transflective unit, a second transflective unit, and a bidirectional backlight source disposed between the first transflective unit and the second transflective unit, wherein:
the bidirectional backlight source is configured to emit light both in a direction toward the first transflective unit and in a direction toward the second transflective unit, and is configured to transmit light from the direction of the first transflective unit and light from the direction of the second transflective unit,
the first transflective unit is configured to transmit light in a first polarization direction and reflect light in a second polarization direction,
the second transflective unit is configured to transmit light in the second polarization direction and reflect light in the first polarization direction, and
the first polarization direction is perpendicular to the second polarization direction.

2. The backlight module of claim 1, wherein the bidirectional backlight source comprises a light guide plate and a light source disposed at a side edge of the light guide plate.

3. The backlight module of claim 1, wherein at least one of the first transflective unit and the second transflective unit comprises at least one of a transflective film, a transflective lens, and an oblique plate stack superposed by glass.

4. The backlight module of claim 1, further comprising a depolarizing film disposed between the first transflective unit and the second transflective unit.

5. The backlight module of claim 4, wherein the depolarizing film is disposed between the bidirectional backlight source and the first transflective unit, the depolarizing film configured to depolarize light in the second polarization direction to be light in the first polarization direction and light in the second polarization direction, and to at least transmit light in the first polarization direction.

6. The backlight module of claim 4, wherein the depolarizing film is disposed between the bidirectional backlight source and the second transflective unit, the depolarizing film configured to depolarize light in the first polarization direction to be light in the first polarization direction and light in the second polarization direction, and to at least transmit light in the second polarization direction.

7. The backlight module of claim 1, further comprising at least one of a first polarizer and a second polarizer, wherein:
the first polarizer is disposed at a side of the first transflective unit opposite the bidirectional backlight source and is configured to transmit light in the first polarization direction and filter out light in the second polarization direction, and
the second polarizer is disposed at a side of the second transflective unit opposite the bidirectional backlight source and is configured to transmit light in the second polarization direction and filter out light in the first polarization direction.

8. The backlight module of claim 1, wherein light in the first polarization direction is one of p light and s light, and light in the second polarization direction is the other one of p light and s light.

9. A method for fabricating a backlight module, comprising:
providing a first transflective unit, a second transflective unit and a bidirectional backlight source; and
disposing the bidirectional backlight source between the first transflective unit and the second transflective unit, wherein:
the bidirectional backlight source is configured to emit light both in a direction toward the first transflective unit and in a direction toward the second transflective unit, and is configured to transmit light from the direction of the first transflective unit and light from the direction of the second transflective unit,
the first transflective unit is configured to transmit light in a first polarization direction and reflect light in a second polarization direction,
the second transflective unit is configured to transmit light in the second polarization direction and reflect light in the first polarization direction, and
the first polarization direction is perpendicular to the second polarization direction.

10. The fabricating method of claim 9, wherein the disposing the bidirectional backlight source between the first transflective unit and the second transflective unit comprises:
coupling the first transflective unit and the second transflective unit on two opposite surfaces of the bidirectional backlight source, respectively.

11. A backlight module, comprising:
a first reflective brightness enhancement unit, a second reflective brightness enhancement unit, and a bidirectional backlight source disposed between the first reflective brightness enhancement unit and the second reflective brightness enhancement unit, wherein:
the bidirectional backlight source is configured to emit light both in a direction toward the first reflective brightness enhancement unit and in a direction toward the second reflective brightness enhancement unit, and is configured to transmit light from the direction of the first reflective brightness enhancement unit and light from the direction of the second reflective brightness enhancement unit,
the first reflective brightness enhancement unit and the second reflective brightness enhancement unit are configured to transmit light in a first polarization direction, depolarize light in a second polarization direction to be light in the first polarization direction and light in the second polarization direction, and reflect both the depolarized light in the first polarization direction and the depolarized light in the second polarization direction back to the bidirectional backlight source, and
the first polarization direction is perpendicular to the second polarization direction.

12. The backlight module of claim 11, wherein the bidirectional backlight source comprises a light guide plate and a light source disposed at a side edge of the light guide plate.

13. The backlight module of claim 11, characterized by at least one of the following:
the first reflective brightness enhancement unit comprises a first transflective unit and a first depolarizing film disposed between the first transflective unit and the bidirectional backlight source; and
the second reflective brightness enhancement unit comprises a second transflective unit and a second depolarizing film disposed between the second transflective unit and the bidirectional backlight source.

14. The backlight module of claim 11, further comprising at least one of a first polarizer and a second polarizer, wherein:
the first polarizer is disposed at a side of the first reflective brightness enhancement unit opposite the bidirectional backlight source; the second polarizer is disposed at a side of the second reflective brightness enhancement unit diverged from the bidirectional backlight source, and
both the first polarizer and the second polarizer are configured to transmit light in the first polarization direction and filter out light in the second polarization direction.

15. The backlight module of claim 11, wherein light in the first polarization direction is one of p light and s light, and light in the second polarization direction is the other one of p light and s light.

16. A method for fabricating the backlight module of claim 11, comprising:
providing the first reflective brightness enhancement unit, the second reflective brightness enhancement unit and the bidirectional backlight source; and
disposing the bidirectional backlight source between the first reflective brightness enhancement unit and the second reflective brightness enhancement unit.

17. A two-sided display device, comprising a first display panel, a second display panel, and a backlight module disposed between the first display panel and the second display panel, wherein the backlight module is the backlight module of claim 1.

18. A two-sided display device, comprising a first display panel, a second display panel, and a backlight module disposed between the first display panel and the second display panel, wherein the backlight module is the backlight module of claim 4.

19. A two-sided display device, comprising a first display panel, a second display panel, and a backlight module disposed between the first display panel and the second display panel, wherein the backlight module is the backlight module of claim 11.

20. A two-sided display device, comprising a first display panel, a second display panel, and a backlight module disposed between the first display panel and the second display panel, wherein the backlight module is the backlight module of claim 13.
